(19) United States
(12) Patent Application Publication
(10) Pub. No.: US 2019/0258252 A1
(43) Pub. Date: Aug. 22, 2019

(54) MOVING BODY, WORK SUPPORT METHOD, AND WORK SUPPORT SYSTEM

(71) Applicant: TOYOTA JIDOSHA KABUSHIKI KAISHA, Toyota-shi (JP)

(72) Inventors: Takahiro MUTA, Mishima-shi (JP); Eisuke ANDO, Nagoya-shi (JP); Takao HISHIKAWA, Nagoya-shi (JP)

(73) Assignee: TOYOTA JIDOSHA KABUSHIKI KAISHA, Toyota-shi (JP)

(21) Appl. No.: 16/271,244

(22) Filed: Feb. 8, 2019

(30) Foreign Application Priority Data
Feb. 16, 2018 (JP) 2018-025877

(51) Int. Cl. G05D 1/00; G05D 1/02

(52) U.S. Cl. CPC G05D 1/0088; G05D 1/0223

(57) ABSTRACT

A moving body, which moves while carrying a user who is executing a work, comprises an acquirer configured to acquire work information in relation to the work to be executed by the user in the moving body; and an adjuster configured to adjust a working environment in the moving body by changing at least any one of setting of equipment of the moving body, a traveling condition, and a traveling route on the basis of the work information. The moving body may further comprise a sensor which measures a state of the working environment; and the adjuster can also adjust the working environment so that a measured value, which is obtained by the sensor, is within a predetermined range which is determined on the basis of the work information.

### CROSS REFERENCE TO RELATED APPLICATION

This application claims the benefit of Japanese Patent Application No. 2018-025877, filed on Feb. 16, 2018, which is hereby incorporated by reference herein in its entirety.

### BACKGROUND

### Technical Field

The present disclosure relates to a moving body, a work support method, and a work support system.

### Description of the Related Art

In general, the vehicle is used in order that a user moves to a desired destination and/or the vehicle is used in order to transport a cargo to a desired delivery destination. Further, such a form is also conceived that the space in the vehicle is used as a space for a user to perform a predetermined working. For example, Patent Document 1 discloses a mobile office which is constructed such that pieces of equipment for business use are arranged usably in vehicles, and the plurality of vehicles are connected to one another. The plurality of vehicles are connected to a connecting vehicle which is provided in order to connect the vehicles. Thus, people can come and go between the vehicles via the connecting vehicle, and an office space, which has an extent as required, is provided. Further, a vehicle, which is arranged with at least one of a power generation apparatus, an air conditioning apparatus, a bathroom, a toilet, and pieces of kitchen equipment, is connected to the connecting vehicle, and thus the comfortability or liveability of the office is enhanced. Note that the mobile office of Patent Document 1 is constructed such that a plurality of vehicles and a connecting vehicle are gathered at a predetermined place, and they are connected to one another at the place.

### PRECEDING TECHNICAL DOCUMENT

### Patent Document

[Patent Document 1]

Japanese Patent Application Laid-Open No. 9-183334

### SUMMARY

When the work is executed in the moving body, the contents of the work are diverse depending on the users. On this account, the working environment, which includes, for example, permittable vibrations or noises, differs depending on the contents of the work. Therefore, if the state of the working environment exceeds a permittable range for the user due to the influence of the noise or the like exerted from the outside, it is feared that the work efficiency of the user may be lowered or deteriorated. However, any sufficient proposal has not been made in order to improve the work efficiency of the user while considering the influence of the noise or the like exerted from the outside during the traveling of the moving body.

The present disclosure has been made in order to solve the problem as described above, an object of which is to provide a technique for suppressing any deterioration of a work efficiency of a user in a moving body.

In order to solve the problem described above, in the present disclosure, the setting of the equipment of the moving body, the traveling condition, and the traveling route may be changed to adjust the working environment in the moving body on the basis of the work information in relation to the work of the user in the moving body.

In particular, the present disclosure resides in a moving body which moves while carrying a user who is executing a work; the moving body may comprising an acquirer configured to acquire work information in relation to the work to be executed by the user in the moving body; and an adjuster configured to adjust a working environment in the moving body by changing at least any one of setting of equipment of the moving body, a traveling condition, and a traveling route on the basis of the work information.

As for the moving body described above, the working environment in the moving body is adjusted depending on the work to be executed by the user during the period until the user moves to a destination after the user gets on the moving body. The work, which is referred to in this application, is the concept including not only the job or task required to be executed by the user in a workplace such as a company or the like, but also, for example, an affair which is personally intended to be executed by the user and an affair which is, for example, requested or required to be executed by the user by another person. That is, the affair is recognized to be executed by the user in relation to the work, and there is no special limitation in relation to, for example, the reason and the background of the execution.

The work information includes the information of, for example, the work contents of the work to be executed by the user in the moving body and the levels of noise and vibration which are permittable during the working depending on the work contents. The setting of the equipment of the moving body includes, for example, the opening/closing of windows, the setting of the density of smoke glass (smoke film) of windows, and the temperature setting for an air conditioner. The traveling condition includes the condition relevant to the traveling including, for example, the traveling speed (traveling velocity), the acceleration, and the deceleration of the moving body. The traveling route is the route provided until the moving body moves to the destination. The speed (velocity) or the acceleration/deceleration can be adjusted and the noise and the vibration can be suppressed by changing the traveling route depending on the work content of the user. The traveling route is changed, for example, by avoiding the traffic jam or detouring the road on which any construction site is present or curves are continued. The moving body adjusts the working environment by changing the setting of the equipment of the moving body, the traveling condition, and the traveling route on the basis of the work information including, for example, the levels of the permittable noise and the permittable the vibration. Accordingly, the moving body can provide the working environment corresponding to the content of the work to be executed by the user in the moving body. It is possible to suppress the deterioration of the work efficiency of the user in the moving body.

Further, the moving body may further comprise a sensor which measures a state of the working environment; and the adjuster may adjust the working environment so that a measured value, which is obtained by the sensor, is within a predetermined range which is determined on the basis of the work information. The sensor includes sensors for measuring the state of the working environment in the moving body, for example, the vibration, the noise, the temperature, and the illuminance. The information, which is acquired by the sensor, can be utilized to judge whether or not the working environment in the moving body is adjusted. The moving body adjusts the working environment by changing at least any one of the setting of the equipment of the moving body, the traveling condition, and the traveling route so that the measured value, which is obtained by the sensor, is within the predetermined range. Further, the predetermined range is determined on the basis of the work information including, for example, the levels of the permittable noise and the permittable vibration. The moving body can provide the proper environment in the moving body to the user by making the control so that the measured value, which is obtained by the sensor, is within the predetermined range which is determined on the basis of the work information.

Further, the acquirer may acquire biometric information of the user; and the adjuster may further adjust the working environment on the basis of the acquired biometric information of the user. The biometric information (biological information) of the user includes the information of, for example, the body temperature, the blood pressure, and the heart rate of the user. The moving body can provide the more comfortable working environment corresponding to, for example, the physical condition of the user by adjusting the working environment on the basis of the biometric information of the user in addition to the work information. Therefore, the moving body can suppress the deterioration of the work efficiency of the user in the moving body.

Further, the adjuster may further control a degree of see-through into an interior of the moving body from outside on the basis of a traveling speed of the moving body. If the traveling speed is low, then the interior of the moving body is easily seen from the outside, and such a situation is not preferred in view of the security in some cases. On this account, the adjuster may make the control such that the slower the traveling speed of the moving body is, the more suppressed the degree of see-through into the interior of the moving body from the outside is. The degree of see-through into the interior of the moving body from the outside is an example of the working environment described above. The degree of see-through can be controlled by changing, for example, the setting of the equipment such as the opening/closing of the window, the density of smoke glass (smoke film) of the window or the like. The moving body can reinforce the security with respect to the work to be executed in the moving body by the user by controlling the degree of see-through into the interior of the moving body from the outside.

In another aspect, the present disclosure can be also grasped from a viewpoint of a method. For example, the present disclosure resides in a work support method may comprising allowing a moving body which moves while carrying a user who is executing a work to acquire work information in relation to the work to be executed by the user in the moving body; and adjust a working environment in the moving body by changing at least any one of setting of equipment of the moving body, a traveling condition, and a traveling route on the basis of the work information.

In still another aspect, the present disclosure can be also grasped from a viewpoint of a non-transitory storage medium stored with a program. For example, the present disclosure resides in a non-transitory storage medium stored with a work support program, wherein the work support program may allow a computer of a moving body which moves while carrying a user who is executing a work to execute a step of acquiring work information in relation to the work to be executed by the user in the moving body; and a step of adjusting a working environment in the moving body by changing at least any one of setting of equipment of the moving body, a traveling condition, and a traveling route on the basis of the work information.

In still another aspect, the present disclosure can be also grasped from a viewpoint of a system. For example, the present disclosure resides in a work support system may comprising a moving body which moves while carrying a user who is executing a work; and a manager configured to manage the moving body; the manager may including an acquirer configured to acquire work information in relation to the work to be executed by the user in the moving body; and an instructor configured to transmit, to the moving body, an instruction to change at least any one of setting of equipment of the moving body, a traveling condition, and a traveling route on the basis of the work information; and the moving body including an adjuster may configured to adjust a working environment in the moving body by changing at least any one of the equipment, the traveling condition, and the traveling route by receiving the instruction from the manager.

Note that the work support system of the present disclosure may be composed of one or a plurality of processing apparatus or processing apparatuses such as a computer or computers or the like. When the work support system is composed of the plurality of processing apparatuses, the respective configurations of the work support system are provided in a dispersed or decentralized manner in the plurality of processing apparatuses, and the respective processing apparatuses cooperate to realize the processing as the work support system. Further, the work support system of the present disclosure may be formed on the moving body, or the work support system of the present disclosure may be formed outside the moving body. Further, the technical concept, which is disclosed in relation to the moving body described above, can be also applied to the work support method, the work support program, and the work support system described above within a range in which any technical inconsistency does not occur.

According to the present disclosure, it is possible to provide the technique for suppressing any deterioration of the work efficiency of the user in the moving body.

### BRIEF DESCRIPTION OF THE DRAWINGS

FIG. 1 illustrates a schematic arrangement of a work support system according to an embodiment.

FIG. 2 exemplifies schematic arrangements of a moving body, a management server, and a user terminal shown in FIG. 1.

FIG. 3 exemplifies a data structure of the traveling condition corresponding to the noise level.

FIG. 4 exemplifies a data structure of the traveling condition corresponding to the vibration level.

FIG. 5 exemplifies the work information of a user who executes the working in the moving body.

FIG. 6 exemplifies a data structure of the moving body management information stored in the management server.

FIG. 7 illustrates a flow chart exemplifying a work support process according to the embodiment.

FIG. 8 illustrates a flow chart exemplifying a work support process according to a first modified embodiment.

FIG. 9 illustrates a flow chart exemplifying a work support process according to a second modified embodiment.

FIG. 10 exemplifies a data structure of the equipment setting depending on the traveling speed.

FIG. 11 exemplifies schematic arrangements of a moving body, a management server, and a user terminal according to a third modified embodiment.

### DESCRIPTION OF THE EMBODIMENTS

An explanation will be made below on the basis of the drawings about a specified embodiment of the present disclosure. The configuration, which is described in the embodiment of the present disclosure, is not intended to limit the technical scope of the disclosure only thereto, unless specifically noted.

### Embodiment

### <Work Support System>

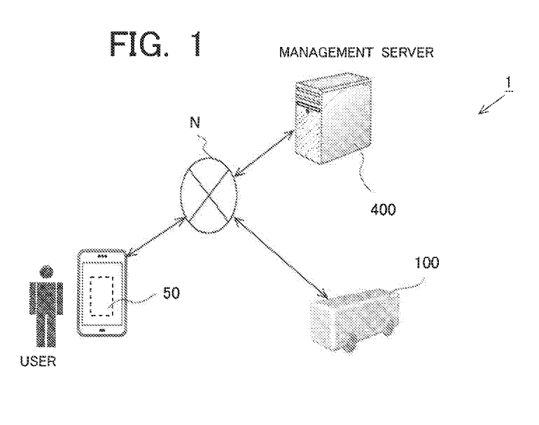

FIG. 1 shows a schematic arrangement of a work support system according to an embodiment. With reference to FIG. 1, the work support system 1 includes a moving body 100 and a management server 400 which are connected to the network N in a manner capable of making communication. Further, the moving body 100 can acquire the work information in relation to the work to be executed by a user from a user terminal 50 via the network N.

The network N is, for example, the public communication network such as the internet or the like, for which it is possible to adopt any communication network such as WAN (Wide Area Network) and the like. Further, the network N may include the cellular network such as LTE (Long Term Evolution) or the like and the wireless network such as the wireless LAN (Local Area Network) or the like including WiFi (registered trademark).

The management server 400 is managed by a moving body management dealer who manages the operation of the moving body 100 for providing the working space for the user. The management server 400 manages the information concerning the moving body 100. The information concerning the moving body 100 includes, for example, the information which indicates the present position and the destination of the moving body 100, the information which indicates the operation schedule, and the information which is relevant to the user who gets on the moving body 100. The management server 400 can acquire, from the user terminal 50, the information relevant to the user who gets on the moving body 100. The management server 400 gives the instruction to the moving body 100 to perform the control so that the working environment is adjusted on the basis of the work information in relation to the work to be executed by the user in the moving body 100. Further, the management server 400 gives the instruction to the moving body 100 to perform the control so that the moving body 100 is moved to a predetermined position (destination) in accordance with the operation schedule.

The moving body 100 has the working space for the user to execute the work. The moving body 100 adjusts the working environment on the basis of the work information in relation to the work to be executed by the user in the moving body. The moving body 100 can acquire, from the user terminal 50, the work information in relation to the work to be executed by the user. Note that the moving body 100 may acquire the work information from the user terminal 50 via the management server 400. The work information includes the information of, for example, the work content and the levels of noise and vibration permittable during the working depending on the work content.

The moving body 100 adjusts the working environment by changing at least any one of the setting of the equipment of the moving body 100, the traveling condition, and the traveling route on the basis of the acquired work information. Specifically, for example, the moving body 100 can adjust the working environment by changing the traveling condition such as the speed (velocity), the acceleration/deceleration and the like of the moving body 100 on the basis of the levels of the noise and the vibration permittable during the working.

### <System Configuration>

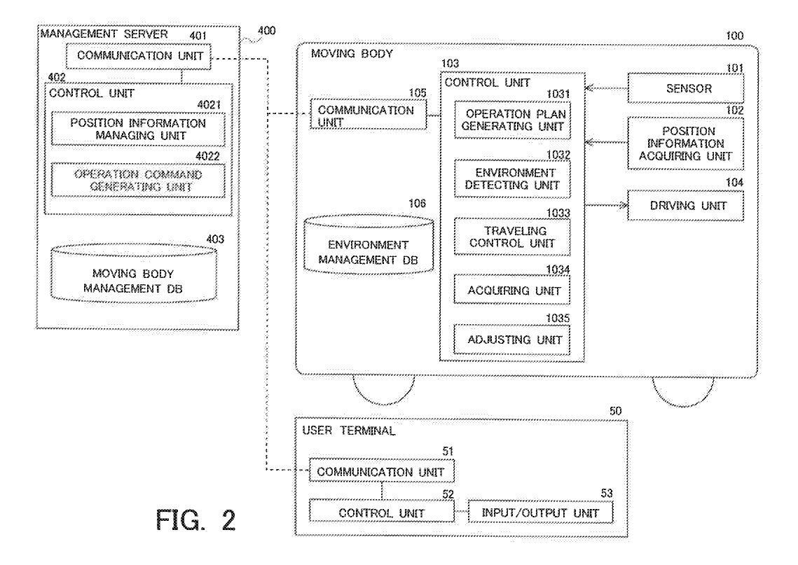

FIG. 2 exemplifies schematic arrangements of the moving body, the management server, and the user terminal. An explanation will be made on the basis of FIG. 2 about the hardware configuration and the functional configuration of the moving body 100, the management server 400, and the user terminal 50.

### <<Moving Body>>

The moving body 100 is an autonomous traveling vehicle which performs the autonomous traveling on the basis of a given command. However, the moving body 100 may be a ship or an aircraft (for example, an airplane or a helicopter), provided that the user can perform the working concerning the work in the moving body 100. In this embodiment, the moving body 100 is the vehicle which performs the autonomous traveling on the road. For example, the moving body 100 can accept the utilization request from the user via the user terminal 50, and the moving body 100 can move to a getting-on position designated by the user. When the user gets on the moving body 100, the moving body 100 moves to the destination designated by the user. The route to arrive at the getting-on position or the destination designated by the user is appropriately determined, for example, by the moving body 100 or the management server 400.

Further, it is not necessary indispensable that the moving body 100 always performs the autonomous movement. For example, the movement may be performed by the manual steering. The steering may be either the steering performed by any person who gets on the moving body 100 or the remote operation based on the use of a remote controller or the like.

The moving body 100 can travel in accordance with an operation command acquired from the management server 400. Specifically, the traveling route is generated on the basis of the operation command acquired via the wireless communication, and the moving body 100 travels on the road by means of a method adequate for the autonomous traveling while performing the sensing around the moving body 100. The moving body 100 is constructed to include a sensor 101, a position information acquiring unit 102, a control unit 103, a driving unit 104, a communication unit 105, and an environment management DB (database) 106. An unillustrated battery (secondary battery) is carried on the moving body 100. The moving body 100 is operated by the electric power supplied from the secondary battery.

The sensor 101 includes sensors for measuring the states of the working environment of the moving body 100 including, for example, the vibration, the noise, the temperature, and the illuminance. The information, which is acquired by the sensor 101, is transmitted to the control unit 103, and the information is utilized to judge whether or not the working environment is adjusted in the moving body 100. Further, the sensor 101 includes a sensor for performing the sensing around the moving body 100 in order to acquire the information required for the autonomous traveling of the moving body 100. The sensor 101 includes, for example, a stereo camera, a laser scanner, LIDAR, and a radar. The information, which is acquired by the sensor 101, is transmitted to the control unit 103. The information is utilized by the control unit 103, for example, in order to recognize the traveling lane and/or the obstacle existing around the moving body 100. In this embodiment, the sensor 101 includes, for example, a noise meter and a vibration meter to measure the noise and the vibration in the moving body 100, and a visible light camera to perform the monitoring of the outside of the moving body. Further, the position information acquiring unit 102 acquires the present position of the moving body 100. For example, the position information acquiring unit 102 is constructed to include, for example, a GPS (Global Positioning System) receiver. The information, which is acquired by the position information acquiring unit 102, is also transmitted to the control unit 103. For example, the information is utilized for a predetermined process such as the calculation of the route in order that the moving body 100 arrives at the destination by utilizing the present position of the moving body 100.

The control unit 103 is a computer which performs a process in relation to the autonomous traveling of the moving body 100 and a process in relation to the support for the sorting (assortment) of cargoes accommodated in the moving body 100 on the basis of the information acquired from the sensor 101 and/or the position information acquiring unit 102. The control unit 103 includes, for example, CPU (Central Processing Unit), a memory, and an auxiliary storage device (for example, a hard disk), although any one of these component is not shown. Programs, which are stored in the auxiliary storage device, are loaded into the memory and executed by CPU, and thus the functions are realized to perform the various processes described above. As specified examples of the various processes, the control unit 103 functions as an operation plan generating unit 1031, an environment detecting unit 1032, a traveling control unit 1033, an acquiring unit 1034, and an adjusting unit 1035.

The operation plan generating unit 1031, the environment detecting unit 1032, and the traveling control unit 1033 are functional units for executing the processes in relation to the autonomous traveling of the moving body 100. Further, the acquiring unit 1034 and the adjusting unit 1035 are functional units for executing the processes in relation to the adjustment of the working environment in the moving body 100.

The operation plan generating unit 1031 acquires the operation command from the management server 400, and the operation plan generating unit 1031 generates the operation plan of itself. The information, which relates to the departure place and the destination given to the moving body 100, is included in the operation command. Therefore, the operation plan generating unit 1031 calculates the moving route of the moving body 100, and the operation plan generating unit 1031 generates the operation plan for moving along the moving route, on the basis of the destination given from the management server 400 and the position of the moving body 100 itself obtained from the position information acquiring unit 102. The departure place and the destination, which are given from the management server 400, are, for example, the getting-on position to get on the moving body 100 and the destination of movement designated by the user. The operation plan includes the data which relates to the route along which the moving body 100 travels as calculated as described above and the data which defines the process to be performed by the moving body 100 on a part or all of the route. The data, which is included in the operation plan, is exemplified, for example, by those described in (1) and (2) as follows.

(1) Data in which route for allowing moving body 100 to travel is represented by set of road links

The route, on which the moving body 100 travels, may be automatically generated, for example, on the basis of the given departure place and the destination by making reference to the stored map data. Note that the calculation of the route for allowing the moving body 100 to travel may rely on any process of an external apparatus (for example, the management server 400) without using any internal apparatus of the moving body 100. In this case, the management server 400 acquires the position of the moving body 100 of itself from the moving body 100, and the management server 400 calculates the route along which the moving body 100 should advance. Further, the calculated route data may be either included in the operation command described above or transmitted to the moving body 100 distinctly.

(2) Data which represents process to be performed by moving body 100 of itself at any point on route

The process, which is to be performed by the moving body 100 itself, includes, for example, “allow user to get on or get off moving body 100” and “temporarily stop” under a predetermined condition. However, there is no limitation thereto. The operation plan, which is generated by the operation plan generating unit 1031, is transmitted to the traveling control unit 1033 described later on.

The environment detecting unit 1032 detects the environment around the moving body 100 used for the autonomous traveling, on the basis of the data acquired by the sensor 101. The detection target is, for example, the number and the position(s) of the lane(s), the number and the position(s) of other vehicle(s) existing around the moving body 100, the number and the position(s) of the obstacle(s) existing around the moving body 100 itself (for example, pedestrian, bicycle, structure, and building), the structure of the road, and the road sign. However, there is no limitation thereto. The detection target may be anyone provided that the target is required to perform the autonomous traveling. For example, when the sensor 101 is a stereo camera, the object existing around the moving body 100 is detected by performing the image processing for the image data picked up thereby. Further, the environment detecting unit 1032 not only merely detects the object existing around the moving body 100, but the detected object may be also subjected to the tracking (detected object is continuously detected successively). For example, it is possible to determine the relative velocity of the object from the difference between the coordinates of the object detected one step before and the present coordinates of the object. The data relevant to the environment around the moving body 100 (hereinafter referred to as “environment data”), which is detected by the environment detecting unit 1032, is transmitted to the traveling control unit 1033 described later on.

The traveling control unit 1033 generates the control command in order to control the autonomous traveling of the moving body 100 on the basis of the operation plan generated by the operation plan generating unit 1031, the environment data generated by the environment detecting unit 1032, and the position information of the moving body 100 acquired by the position information acquiring unit 102. For example, the traveling control unit 1033 generates the control command in order to allow the moving body 100 to travel so that the moving body 100 travels along a predetermined route and any obstacle does not enter a predetermined safe area around the center of the moving body 100. The generated control command is transmitted to the driving unit 104 described later on. As for the method for generating the control command for allowing the moving body to perform the autonomous traveling, it is possible to adopt any known method.

The acquiring unit 1034 acquires the work information in relation to the work to be executed by the user in the moving body 100. The work information includes, for example, the information of the work content, and the levels of the noise and the vibration permittable during the working depending on the work content. The acquiring unit 1034 can receive the work information inputted by the user with the user terminal 50.

The adjusting unit 1035 adjusts the working environment of the moving body 100 on the basis of the work information received by the acquiring unit 1034. Specifically, the adjusting unit 1035 can provide the comfortable working environment to the user by changing, for example, the setting of the equipment of the moving body 100, the traveling condition, or the traveling route on the basis of the information of, for example, the levels of the noise and the vibration permittable during the working as included in the work information.

The driving unit 104 is the means for allowing the moving body 100 to travel on the basis of the control command generated by the traveling control unit 1033. The driving unit 104 is constructed to include, for example, a motor for driving wheels provided for the moving body 100, an inverter, a brake, and a steering mechanism. For example, the motor and the brake are driven in accordance with the control command, and thus the autonomous traveling of the moving body 100 is realized.

The communication unit 105 connects the moving body 100 to the network N. For example, a network interface card (NIC, not shown) is applied as the communication unit 105. In this embodiment, the communication unit 105 can make communication with other apparatuses (for example, the management server 400) via the network N by utilizing the mobile communication service such as 3G (3rd Generation), LTE (Long Term Evolution) or the like.

The environment management DB 106 stores various pieces of information in relation to the working environment in the moving body 100. The environment management DB 106 is constructed such that the program of the database management system (Database Management System, DBMS), which is executed by the processor, manages the data stored in the auxiliary storage device. The environment management DB 106 is, for example, a relational database.

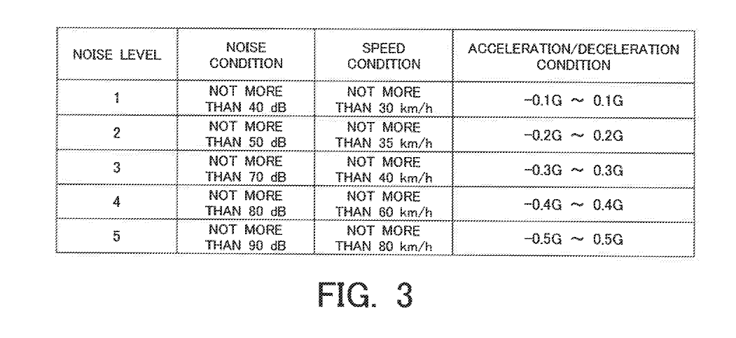

An explanation will now be made on the basis of FIGS. 3 to 5 about the information of the traveling condition corresponding to the noise level of the user stored in the environment management DB 106, the information of the traveling condition corresponding to the vibration level, the traveling condition corresponding to the state of the working environment, and the configuration of the work information.

FIG. 3 exemplifies a data structure of the traveling condition corresponding to the noise level. A traveling condition table for noise, which stores the information of the traveling condition corresponding to the noise level, is used to define the condition of the speed (velocity) and the acceleration/deceleration of the moving body 100 corresponding to the noise level. The traveling condition table for noise has respective fields of “noise level”, “noise condition”, “speed condition”, and “acceleration/deceleration condition”. The noise level field stores the noise level allowed to correspond to ranges of various conditions. In the example shown in FIG. 3, five noise levels from 1 to 5 are defined. Various conditions are defined so that the lower the noise level is, the more suppressed the noise is.

The noise condition field stores the range of the noise assumed by the noise level. For example, if the noise level, which is permitted corresponding to the work content of the user, is “2”, the moving body 100 is controlled so that the noise, which is measured by the sensor 101, is not more than 50 dB. The moving body 100 is subjected to the control so that the noise is reduced, for example, by performing the deceleration and/or changing the traveling route.

The speed condition field stores the range of the speed of the moving body 100 corresponding to the noise level. For example, if the noise level, which is permitted corresponding to the work content of the user, is “2”, the speed of the moving body 100 is controlled to be not more than 35 km/h. Therefore, when the permitted noise level is “2”, if the speed of the moving body 100 exceeds 35 km/h, then the moving body 100 changes the speed so that the speed is not more than 35 km/h.

The acceleration/deceleration condition field stores the range of the acceleration/deceleration of the moving body 100 corresponding to the noise level. For example, if the noise level, which is permitted corresponding to the work content of the user, is “2”, the acceleration/deceleration of the moving body 100 is controlled so that the acceleration/deceleration is within a range of −0.2 G to 0.2 G (G: gravitational acceleration). Therefore, if the permitted noise level is “2”, the moving body 100 is controlled so that the moving body 100 does not perform the acceleration and the deceleration in which the acceleration/deceleration exceeds the range of −0.2 G to 0.2 G.

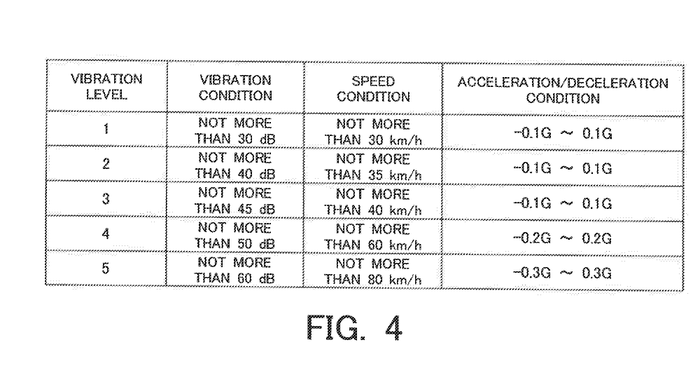

FIG. 4 exemplifies a data structure of the traveling condition corresponding to the vibration level. A traveling condition table for vibration, which stores the information of the traveling condition corresponding to the vibration level, is used to define the condition of the speed (velocity) and the acceleration/deceleration of the moving body 100 corresponding to the vibration level. The traveling condition table for vibration has respective fields of “vibration level”, “vibration condition”, “speed condition”, and “acceleration/deceleration condition”. The vibration level field stores the vibration level allowed to correspond to ranges of various conditions. In the example shown in FIG. 4, five vibration levels from 1 to 5 are defined. Various conditions are defined so that the lower the vibration level is, the more suppressed the vibration is.

The vibration condition field stores the range of the vibration assumed by the vibration level. For example, if the vibration level, which is permitted corresponding to the work content of the user, is “3”, the moving body 100 is controlled so that the vibration, which is measured by the sensor 101, is not more than 45 dB. The moving body 100 is subjected to the control so that the vibration is reduced, for example, by performing the deceleration and/or changing the traveling route.

The speed condition field stores the range of the speed of the moving body 100 corresponding to the vibration level. For example, if the vibration level, which is permitted corresponding to the work content of the user, is “3”, the speed of the moving body 100 is controlled to be not more than 40 km/h. Therefore, when the permitted vibration level is “3”, if the speed of the moving body 100 exceeds 40 km/h, then the moving body 100 changes the speed so that the speed is not more than 40 km/h.

The acceleration/deceleration condition field stores the range of the acceleration/deceleration of the moving body 100 corresponding to the vibration level. For example, if the vibration level, which is permitted corresponding to the work content of the user, is “3”, the acceleration/deceleration of the moving body 100 is controlled so that the acceleration/deceleration is within a range of −0.1 G to 0.1 G (G: gravitational acceleration). Therefore, if the permitted vibration level is “3”, the moving body 100 is controlled so that the moving body 100 does not perform the acceleration and the deceleration in which the acceleration/deceleration exceeds the range of −0.1 G to 0.1 G.

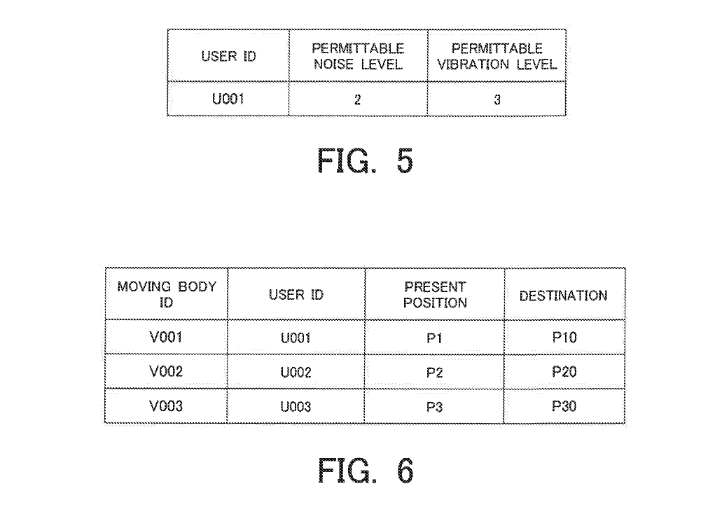

FIG. 5 exemplifies the work information of the user who executes the working in the moving body 100. The moving body 100 receives the work information from the user terminal 50, and the received work information is stored in a work information table. The work information table, which stores the work information, has respective fields of “user ID”, “permittable noise level”, and “permittable vibration level”. The work information table has one record for storing the information in relation to one user who gets on the moving body 100.

The user ID fields stores the user ID for identifying the user who gets on the moving body 100. The permittable noise level field stores the level of the permittable noise when the user executes the work in the moving body 100. In the example shown in FIG. 5, “2” is set for the level of the permittable noise. In this case, according to the example of the traveling condition table for noise shown in FIG. 3, the noise in the moving body 100 is controlled so that the noise is not more than 50 dB. Further, the speed of the moving body 100 is controlled to be not more than 35 km/h, and the acceleration/deceleration is controlled to be within a range of −0.2 G to 0.2 G.

The permittable vibration level field stores the level of the permittable vibration when the user executes the work in the moving body 100. In the example shown in FIG. 5, “3” is set for the permittable vibration level. In this case, according to the example of the traveling condition table for vibration shown in FIG. 4, the vibration in the moving body 100 is controlled so that the vibration is not more than 45 dB. Further, the speed of the moving body 100 is controlled to be not more than 40 km/h, and the acceleration/deceleration is controlled to be within a range of −0.1 G to 0.1 G.

Note that in the example shown in FIG. 5, the speed condition based on the noise level has the range which is narrower than that of the speed condition based on the vibration level. Further, the acceleration/deceleration condition based on the vibration level has the range which is narrower than that of the acceleration/deceleration condition based on the noise level. In this case, the adjusting unit 1035 of the moving body 100 may adjust the working environment by changing the speed condition and the acceleration/deceleration condition while making adjustment to the narrower range.

### <<Management Server>>

Next, the management server 400 will be explained. The management server 400 is the apparatus which manages the autonomous traveling of the moving body 100 and which transmits the operation command. For example, if the management server 400 receives the request for utilization of the moving body 100 from the user, then the management server 400 determines the moving body to be allocated to the user, and the management server 400 transmits the operation command to the determined moving body 100. The management server 400 receives the work information in relation to the work to be executed in the moving body 100 by the user together with the utilization request for utilizing the moving body 100, and the management server 400 transmits the received work information to the moving body 100.

The management server 400 is configured as a general computer. Specifically, the management server 400 includes a processor (not shown) such as CPU, DSP (Digital Signal Processor) and the like, a memory (not shown) such as RAM (Random Access Memory), ROM (Read Only Memory) and the like, and an auxiliary storage device (not shown) such as EPROM (Erasable Programmable ROM), a hard disk drive (HDD, Hard Disk Drive), a removable media and the like. The removable media is, for example, a disk storage medium such as USB (Universal Serial Bus) memory, CD (Compact Disc), DVD (Digital Versatile Disc) and the like. For example, an operating system (Operating System: OS), various programs, and various tables are stored in the auxiliary storage device. The programs stored in the auxiliary storage device are loaded and executed by the processor on the working area of the memory, and various processes and operations are performed in accordance with the execution of the programs. Thus, it is possible to realize the functions which conform to the predetermined purpose.

The management server 400 has a communication unit 401. The communication unit 401 is connected to another apparatus via the network N to perform the communication, for example, with respect to the moving body 100 and the user terminal 50. The communication unit 401 is, for example, NIC or a wireless communication circuit for the wireless communication. NIC or the wireless communication circuit is connected to the network N.

Further, the management server 400 has, in its auxiliary storage device, the moving body management DB 403 which stores various pieces of information in relation to the plurality of moving bodies 100 that perform the autonomous traveling. This database (Database) is constructed such that the program of the database management system (Database Management System, DBMS), which is executed by the processor, manages the data stored in the auxiliary storage device. The moving body management DB 403 is, for example, a relational database.

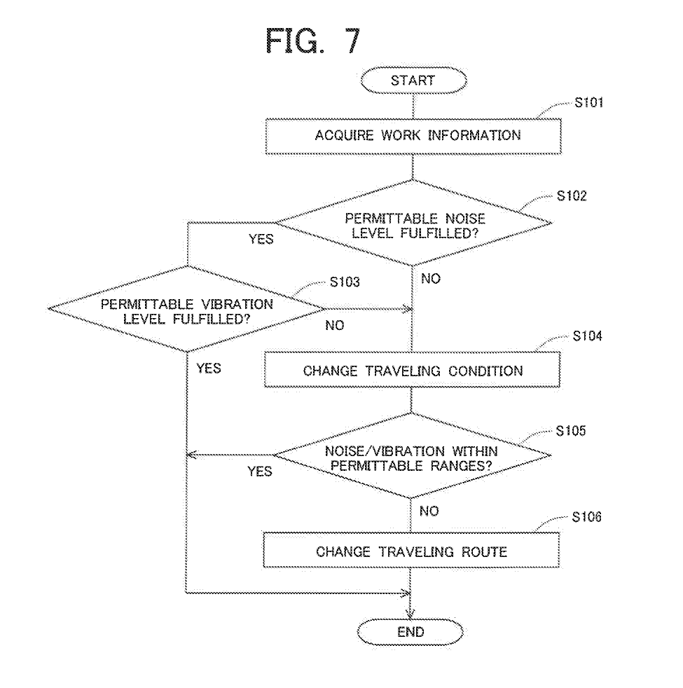

An explanation will now be made on the basis of FIG. 6 about the configuration of the moving body management information stored in the moving body management DB 403. FIG. 6 exemplifies a data structure of the moving body management information stored in the management server 400. A moving body management information table, which stores the moving body management information, has respective fields of “moving body ID”, “user ID”, “present position”, and “destination”. The moving body ID field stores the moving body ID for identifying the moving body 100 managed by the management server 400. The user ID field deals with the user ID for identifying the user for whom the moving body 100 is allocated. If the management server 400 accepts the utilization request for utilizing the moving body 100 from the user, the management server 400 stores the user ID of the user as the request source, in the user ID field of the record corresponding to the allocated moving body 100.

The present position field stores the information for specifying the place at which each of the moving bodies 100 is positioned at the present point in time. Specifically, the present position is the information which relates to the latitude and the longitude for specifying the present position of the moving body 100. Every time when the information about the present position, which is acquired by the position information acquiring unit 102 of the moving body 100, is transmitted from the moving body 100 to the management server 400, the present position field, which corresponds to the moving body 100 in the moving body management DB 403, is updated. The destination field stores the destination of the user who goes by the moving body 100. The management server 400 receives the information of the destination together with the utilization request from the user, and the management server 400 stores the information in the destination field.

Further, in the management server 400, the program is executed by the processor as described above, and thus the control unit 402 is formed as a functional unit. As described above, the control unit 402 performs, for example, the process in relation to the autonomous traveling of the moving body 100 and the process in relation to the support of the sorting (assortment) of cargoes accommodated in the moving body 100. In particular, the control unit 402 operates, for example, as the functional units of the position information managing unit 4021 and the operation command generating unit 402. Especially, the position information managing unit 4021 and the operation command generating unit 4022 execute the processes in relation to the autonomous traveling of the moving body 100.

At first, the position information managing unit 4021 and the operation command generating unit 4022 will be explained. The position information managing unit 4021 collects and manages the position information from the plurality of moving bodies 100 which are managed by the management server 400. Specifically, the present position information is received from the plurality of moving bodies 100 at the concerning point in time in every predetermined cycle, and the information is stored in the moving body management DB 403.

If the utilization request for utilizing the moving body 100 is accepted from the user, then the operation command generating unit 4022 determines the moving body 100 to go to pickup the user, and the operation command generating unit 4022 generates the operation command corresponding to the getting-on position included in the utilization request. The operation command may include the information which indicates the route to arrive at the getting-on position of the user. The getting-on position may be either a getting-on position which is designated by the user who transmitted the utilization request or a predetermined getting-on position such as a stop or the like for utilizing the moving body 100.

### <<User Terminal>>

The user terminal 50 is used by the user who executes the work in the moving body 100 which is provided to move to the destination. The user terminal 50 may be a portable terminal such as a smart device or the like including, for example, smartphones and tablets, a personal computer, a workstation, or a terminal which is carried on the moving body 100. The user terminal 50 has a communication unit 51, a control unit 52, and an input/output unit 53. Devices, which are of the same types as those of the devices for constructing the communication unit 401 and the control unit 402 of the management server 400, can be applied as the communication unit 51 and the control unit 52. The input/output unit 53 includes an input device (for example, button, key, pointing device, touch panel, and microphone) and an output device (for example, display and speaker).

The user inputs, into the user terminal 50, the work information in relation to the work to be executed in the moving body 100. The user terminal 50 transmits, to the management server 400, the utilization request for utilizing the moving body 100 together with the work information inputted by the user. Further, the user terminal 50 may transmit, to the moving body 100, the work information inputted by the user without allowing the management server 400 to intervene. Further, for example, if the permittable noise level or the permittable vibration level is changed on account of any change of the work to be executed in the moving body 100, the user may transmit, to the moving body 100, the work information including the foregoing information again. Accordingly, the moving body 100 can adjust the working environment again on the basis of the work information in relation to the work after the change.

Any one of the respective functional constitutive elements or components of the moving body 100 and the management server 400 or a part of the process thereof may be executed by another computer connected to the network N. Further, the series of processes executed by the moving body 100 and the management server 400 can be executed by the hardware, but the processes can be also executed by the software. The user terminal 50 can be also dealt with in the same manner as described above.

### <Flow of Process>

FIG. 7 shows a flow chart exemplifying a work support process according to the embodiment. The flow of the process is started, for example, taking the opportunity of the fact that the user gets on the moving body 100 to start the movement to the destination.

At first, in S101, the acquiring unit 1034 of the moving body 100 acquires the work information. The work information is the work content relevant to the work to be executed by the user in the moving body 100, and the work information includes the information of the permittable noise level and the permittable vibration level. For example, in the case of the example of the work information table shown in FIG. 5, the permittable noise level is “2” and the permittable vibration level is “3” for the user having the user ID of U001 (hereinafter referred to as “user U001”). Note that the acquiring unit 1034 may acquire the work information before the user gets on the moving body 100, or the acquiring unit 1034 may acquire the work information during the movement until arrival at the destination.

In S102, the adjusting unit 1035 of the moving body 100 judges whether or not the working environment in the moving body 100 fulfills the permittable noise level acquired in S101. The adjusting unit 1035 can judge whether or not the working environment fulfills the permittable noise level depending on whether or not the speed and the acceleration/deceleration of the moving body 100 are within predetermined ranges. For example, if the permittable noise level is “2”, it is appropriate that the speed is not more than 35 km/h and the acceleration/deceleration is within a range of −0.2 G to 0.2 G in the case of the example of the traveling condition table for noise shown in FIG. 3. Further, the adjusting unit 1035 may judge that the working environment fulfills the permittable noise level, if the noise, which is measured by the noise meter included in the sensor 101, is not more than 50 dB. If the working environment fulfills the permittable noise level (S102: Yes), the process proceeds to S103. If the working environment does not fulfill the permittable noise level (S102: No), the process proceeds to S104.

In S103, the adjusting unit 1035 of the moving body 100 judges whether or not the working environment in the moving body 100 fulfills the permittable vibration level acquired in S101. The adjusting unit 1035 can judge whether or not the working environment fulfills the permittable vibration level depending on whether or not the speed and the acceleration/deceleration of the moving body 100 are within predetermined ranges. For example, if the permittable vibration level is “3”, it is appropriate that the speed is not more than 40 km/h and the acceleration/deceleration is within a range of −0.1 G to 0.1 G in the case of the example of the traveling condition table for vibration shown in FIG. 4. Further, the adjusting unit 1035 may judge that the working environment fulfills the permittable vibration level, if the vibration, which is measured by the vibration meter included in the sensor 101, is not more than 45 dB. If the working environment fulfills the permittable vibration level (S103: Yes), the work support process shown in FIG. 7 is terminated. If the working environment does not fulfill the permittable vibration level (S103: No), the process proceeds to S104.

In S104, the adjusting unit 1035 of the moving body 100 changes the traveling condition including the speed and the acceleration/deceleration. The adjusting unit 1035 controls the speed and the acceleration/deceleration of the moving body 100 so that the working environment fulfills the permittable noise level and the permittable vibration level. If any one of the permittable noise level and the permittable vibration level is not acquired, the adjusting unit 1035 may change the traveling condition of the speed and the acceleration/deceleration so that the working environment fulfills the acquired permittable noise level or the acquired permittable vibration level.

In S105, the adjusting unit 1035 of the moving body 100 judges whether or not the noise and the vibration are within the permittable ranges. For example, if the traveling condition is not changed on account of the situation of the road on which the moving body 100 is traveling, the adjusting unit 1035 can judge that the noise and the vibration are not within the permittable ranges.

Further, if the noise or the vibration, which is measured by the sensor 101, does not fulfill the noise condition corresponding to the permittable noise level or the vibration condition corresponding to the permittable vibration level after changing the traveling condition in S104, the adjusting unit 1035 can judge that the noise and the vibration are not within the permittable ranges. Specifically, when the permittable noise level is “2”, if the noise measured by the sensor 101 is not more than 50 dB, then the adjusting unit 1035 can judge that the working environment fulfills the permittable noise level on the basis of the noise condition of the traveling condition table for noise shown in FIG. 3. Further, when the permittable vibration level is “3”, if the vibration measured by the sensor 101 is not more than 45 dB, then the adjusting unit 1035 can judge that the working environment fulfills the permittable vibration level on the basis of the vibration condition of the traveling condition table for vibration shown in FIG. 4.

If the noise and the vibration are within the permittable ranges (S105: Yes), the work support process shown in FIG. 7 is terminated. If the noise and the vibration are not within the permittable ranges (S105: No), the process proceeds to S106.

In S106, the adjusting unit 1035 of the moving body 100 changes the traveling route of the moving body 100. The moving body 100 can reduce the noise or the vibration by acquiring the traffic jam information to avoid the traffic jam and/or acquiring the construction information to detour the road which is under construction. The adjusting unit 1035 can acquire the road traffic information including, for example, the traffic jam information and the construction information, for example, from the road traffic information communication system (VICS (registered trademark), Vehicle Information and Communication System) by the aid of the communication unit 105. Further, the adjusting unit 1035 of the moving body 100 may change the traveling route in accordance with the instruction from the management server 400 which has acquired the road traffic information.

The flow of the work support process shown in FIG. 7 is illustrative of the example in which the working environment is adjusted for the noise and the vibration. However, this embodiment is also applicable when the working environment is adjusted by changing, for example, the temperature and the brightness in the moving body 100. Note that the moving body 100 can also adjust the working environment by executing the work support process shown in FIG. 7 during the movement toward the destination, without being limited to the timing at which the user gets on the moving body 100 to start the movement toward the destination.

### <Function and Effect of Embodiment>

In the embodiment described above, the acquiring unit 1034 of the moving body 100 acquires the work information including the information of the permittable noise level and the permittable vibration level in relation to the work to be executed by the user in the moving body 100. The adjusting unit 1035 of the moving body 100 changes the traveling route and the traveling condition including, for example, the speed and the acceleration/deceleration of the moving body 100 depending on the permittable noise level and the permittable vibration level. Accordingly, the working environment, which corresponds to the content of the work to be executed by the user in the moving body 100, is provided to the user. Therefore, it is possible to suppress the deterioration of the work efficiency of the user in the moving body 100.

The moving body 100 may include the sensor 101 which measures the state of the working environment such as the vibration, the noise or the like, and the moving body 100 may adjusts the working environment so that the measured value, which is obtained by the sensor 101, is within the predetermined range determined on the basis of the work information. The moving body 100 can provide, to the user, the proper working environment in the moving body 100 by making control so that the measured value, which is obtained by the sensor 101, is within the predetermined range determined on the basis of the work information.

### First Modified Embodiment

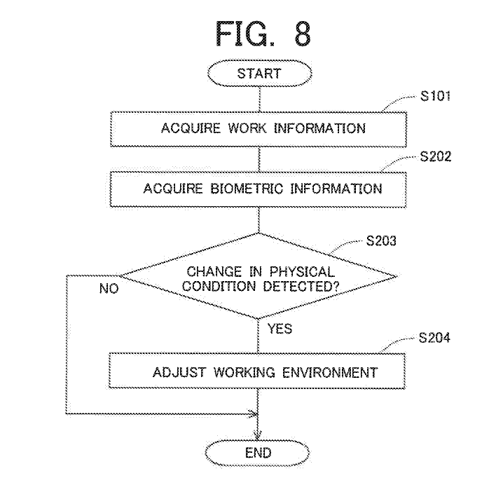

In the embodiment, the moving body 100 adjusts the working environment on the basis of the work information. On the contrary, in a first modified embodiment, the working environment is adjusted on the basis of the biometric information of the user in addition to the work information. The biometric information of the user includes, for example, the information of, for example, the body temperature, the blood pressure, and the heart rate of the user. With reference to FIG. 8, an explanation will be made about processes of the first modified embodiment which are different from those of the embodiment described above. FIG. 8 shows a flow chart exemplifying a work support process according to the first modified embodiment. The flow of the process is started, for example, taking the opportunity of the fact that the user gets on the moving body 100 to start the movement toward the destination. The process of S101 shown in FIG. 8 is the process which is the same as or equivalent to that of S101 shown in FIG. 7, and hence any explanation thereof will be omitted.

In S202, the acquiring unit 1034 of the moving body 100 acquires the biometric information of the user. The biometric information of the user can be acquired, for example, by being inputted into the user terminal 50 by the user or by measuring the biometric information of the user, for example, by means of a wearable terminal which can acquire the biometric information of the user. The acquiring unit 1034 may acquire the biometric information of the user at predetermined intervals, and the acquired biometric information may be stored as the history in the environment management DB 106.

In S203, the acquiring unit 1034 judges whether or not the change in the physical condition of the user is detected. For example, the acquiring unit 1034 previously stores, in the environment management DB 106, the biometric information provided when the user is in the healthy state. If the difference with respect to the biometric information acquired in S202 is not less than a predetermined value, the acquiring unit 1034 can judge that the physical condition of the user changes. Alternatively, the acquiring unit 1034 may detect the change in the physical condition by comparing the biometric information acquired in S202 with the history of the biometric information stored in the environment management DB 106. If the acquiring unit 1034 detects the physical condition change of the user (S203: Yes), the process proceeds to S204. If the acquiring unit 1034 does not detect the physical condition change of the user (S203: No), the process is terminated. Note that if the acquiring unit 1034 does not detect the physical condition change of the user, the process may return to S202.

In S204, the adjusting unit 1035 of the moving body 100 adjusts the working environment. The adjusting unit 1035 can change, for example, the setting temperature of the air conditioner in the moving body 100 depending on the change of the body temperature or the heart rate of the user. Further, if the increase in the blood pressure of the user is detected, the adjusting unit 1035 may decelerate or stop the moving body 100. Further, the adjusting unit 1035 can also adjust the working environment depending on the work information in the same manner as in S102 to S106 shown in FIG. 7, in addition to the adjustment of the working environment based on the biometric information.

In the first modified embodiment, the adjusting unit 1035 adjusts the working environment on the basis of the biometric information of the user in addition to the work information. Therefore, the adjusting unit 1035 can provide the more comfortable working environment corresponding to the physical condition of the user, and it is possible to suppress the deterioration of the work efficiency of the user in the moving body 100.

### Second Modified Embodiment

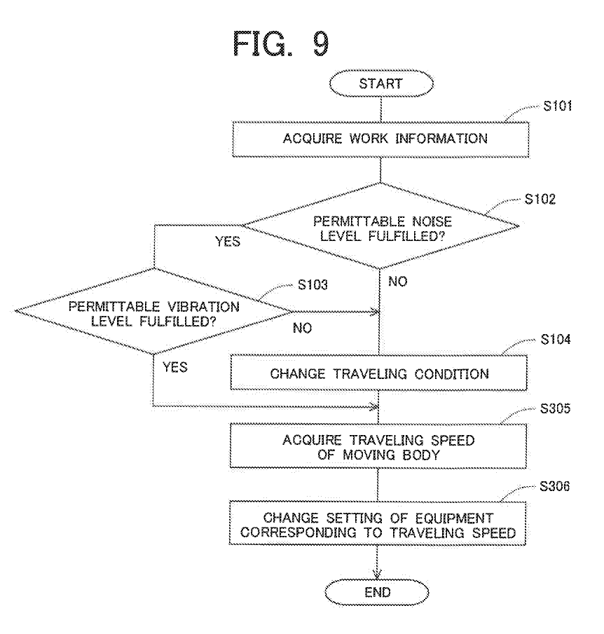

In a second modified embodiment, the setting of the equipment is changed on the basis of the traveling speed of the moving body 100 to control the degree of see-through into the interior of the moving body 100 from the outside. With reference to FIG. 9, an explanation will be made about processes different from those of the embodiment described above, in the second modified embodiment. FIG. 9 shows a flow chart exemplifying a work support process according to the second modified embodiment. The flow of the process is started, for example, taking the opportunity of the fact that the user gets on the moving body 100 to start the movement toward the destination. The processes of S101 to S104 shown in FIG. 9 are the processes which are the same as or equivalent to those affixed with the same reference numerals in FIG. 7, and hence any explanation thereof will be omitted.

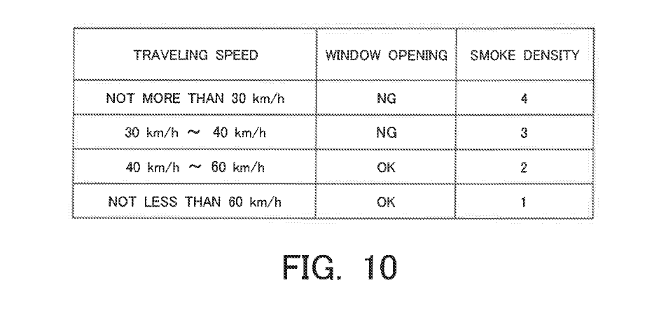

In S305, the acquiring unit 1034 of the moving body 100 acquires the traveling speed of the moving body 100. In S306, the adjusting unit 1035 of the moving body 100 changes the setting of the equipment depending on the traveling speed of the moving body 100 acquired in S305 to control the degree of see-through into the interior of the moving body 100 from the outside. Specifically, for example, the adjusting unit 1035 controls the degree of see-through into the interior of the moving body 100 from the outside by changing the opening/closing of the window or the density of smoke glass (smoke film) of the window. An explanation will now be made on the basis of FIG. 10 about a specified example of the process in which the adjusting unit 1035 changes the opening/closing of the window or the density of smoke glass (smoke film) of the window.

FIG. 10 exemplifies a data structure of the equipment setting depending on the traveling speed. An equipment setting table, which stores the information of the equipment setting depending on the traveling speed, is stored in the environment management DB 106. The equipment setting table is used to define the setting of the equipment of the moving body 100 depending on the traveling speed of the moving body 100. The setting of the equipment is, for example, the setting of, for example, the opening/closing of the window and the density of smoke glass (smoke film) of the window. The equipment setting table has respective fields of “traveling speed”, “window opening”, and “smoke density”.

The traveling speed field stores the range of the traveling speed in order to change the setting of the equipment. In the example shown in FIG. 10, the ranges of the traveling speed of not more than 30 km/h, 30 km/h to 40 km/h, 40 km/h to 60 km/h, and not less than 60 km/h are defined. The setting values of the opening/closing of the window and the smoke density of the window are defined depending on the respective ranges of the traveling speed.

The window opening field stores the definition of whether or not the window of the moving body 100 is allowed to be open depending on the traveling speed. For example, if the traveling speed of the moving body 100 is within the range of 40 km/h to 60 km/h, then “OK” is set in the window opening field, and the window of the moving body 100 may be in the open state. On the other hand, if the traveling speed of the moving body 100 is within the range of 30 km/h to 40 km/h, “NG” is set in the window opening field. If the window of the moving body 100 is open, the adjusting unit 1035 makes control so that the window of the moving body 100 is closed.

The smoke density field stores the definition of the smoke density of the window of the moving body 100 depending on the traveling speed. In the example shown in FIG. 10, the smoke density of the window is switched at four levels. Note that as for the smoke density of the window, the density can be changed by applying the voltage to a liquid crystal sheet interposed by the glass. The smoke density of the window is changed by applying the voltage corresponding to each of the levels stored in the smoke density field. If the traveling speed of the moving body 100 becomes slow, the interior of the moving body 100 can be easily seen from the outside. Therefore, the smoke density is controlled so that the slower the traveling speed is, the denser (darker) the smoke density is.

In the second modified embodiment, the moving body 100 changes the setting of the equipment such as the opening/closing of the window, the smoke density of the window or the like, depending on the traveling speed. Accordingly, the moving body 100 can control the degree of see-through into the interior of the moving body 100 from the outside, and it is possible to intensify the security for the work to be executed in the moving body 100 by the user.

### Third Modified Embodiment

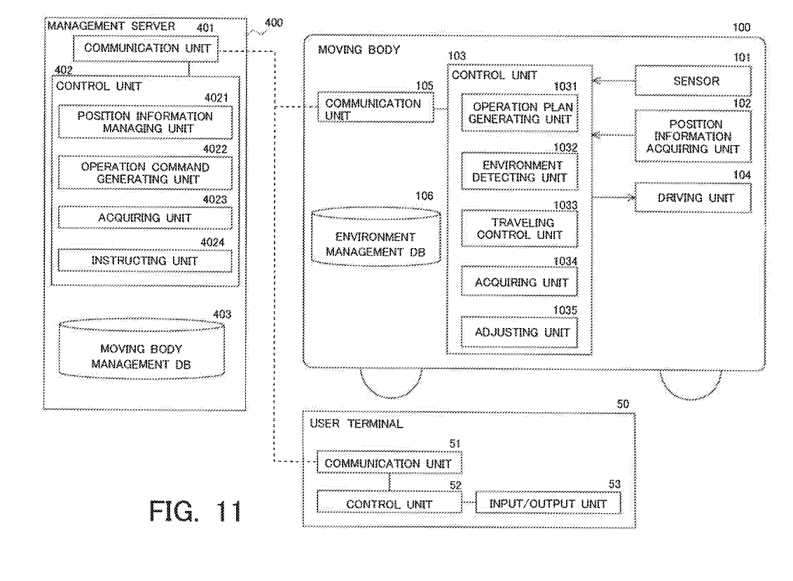

In a third modified embodiment, the management server 400 acquires the work information in relation to the work to be executed in the moving body by the user to instruct the moving body 100 to change at least any one of the setting of the equipment, the traveling condition, and the traveling route. In the third modified embodiment, the configuration of the management server 400 and the process performed by the acquiring unit 1034 of the moving body 100 are different from those of the embodiment described above. With reference to FIG. 11, an explanation will be made in the third modified embodiment about parts or components of the configurations of the moving body 100 and the management server 400 concerning the third modified embodiment which are different from those of the embodiment described above. The other configurations of the apparatuses or devices are the same as or equivalent to the configurations of those affixed with the same reference numerals in FIG. 2, and hence any explanation thereof will be omitted.

FIG. 11 exemplifies schematic arrangements of a moving body, a management server, and a user terminal according to the third modified embodiment. The control unit 402 also operates as an acquiring unit 4023 and an instructing unit 4024 in addition to the position information managing unit 4021 and the operation command generating unit 4022. The acquiring unit 4023 and the instructing unit 4024 execute the processes in relation to the adjustment of the working environment of the moving body 100.

The acquiring unit 4023 acquires, from the user terminal 50, the work information in relation to the work scheduled to be executed by the user in the moving body 100 together with the utilization request, and the acquiring unit 4023 transmits the acquired work information to the acquiring unit 1034 of the moving body 100.

The instructing unit 4024 instructs the moving body 100 to adjust the working environment on the basis of the work information received by the acquiring unit 4023. In this case, the management server 400 stores, in the auxiliary storage device of the management server 400, the data which is the same as or equivalent to that of the traveling condition table for noise shown in FIG. 3 and the traveling condition table for vibration shown in FIG. 4. Then, the instructing unit 4024 transmits, to the moving body 100, the instruction to change the setting of the equipment of the moving body 100, the traveling condition, or the traveling route on the basis of the data stored in the auxiliary storage device and the work information received by the acquiring unit 4023. The adjusting unit 1035 of the moving body 100 can receive the instruction of the management server 400 and adjust the working environment.

In the third modified embodiment, the management server 400 instructs the moving body 100 to change, for example, the setting of the equipment, the traveling condition including, for example, the speed and the acceleration/deceleration, and the traveling route, on the basis of the work information of the work to be executed by the user in the moving body 100. Accordingly, the management server 400 can provide, to the user, the working environment corresponding to the content of the work to be executed by the user in each of the moving bodies 100 which are management targets. Therefore, it is possible to suppress the deterioration of the work efficiency of the user in the moving body 100.

### <Recording Medium>

The program, which allows the computer or other machine or apparatus (hereinafter referred to as “computer or the like”) to realize any one of the functions described above, can be recorded on a recording medium which is readable by the computer or the like. The functions can be provided by reading and executing the program of the recording medium by the computer or the like.

In this context, the recording medium, which is readable by the computer or the like, refers to any non-transitory recording medium on which the information including, for example, the data and the program can be accumulated by means of the electric, magnetic, optical, mechanical, or chemical action and the information can be read by means of the computer or the like. Among the recording media as described above, those removable from the computer or the like are, for example, flexible disk, magneto-optical disk, CD-ROM, CD-R/W, DVD, blue-ray disk, DAT, 8 mm tape, and memory card such as flash memory or the like. Further, the recording medium fixed to the computer or the like includes, for example, hard disk and ROM. Further, SSD (Solid State Drive) can be utilized either as the recording medium which is removable from the computer or the like or as the recording medium which is fixed to the computer or the like.

What is claimed is:

1. A moving body which moves while carrying a user who is executing a work, the moving body comprising:
an acquirer configured to acquire work information in relation to the work to be executed by the user in the moving body; and
an adjuster configured to adjust a working environment in the moving body by changing at least any one of setting of equipment of the moving body, a traveling condition, and a traveling route on the basis of the work information.

2. The moving body according to claim 1, wherein:
the moving body further comprises a sensor which measures a state of the working environment; and
the adjuster adjusts the working environment so that a measured value, which is obtained by the sensor, is within a predetermined range which is determined on the basis of the work information.

3. The moving body according to claim 1, wherein:
the acquirer acquires biometric information of the user; and
the adjuster further adjusts the working environment on the basis of the acquired biometric information of the user.

4. The moving body according to claim 1, wherein the adjuster further controls a degree of see-through into an interior of the moving body from outside on the basis of a traveling speed of the moving body.

5. A work support method comprising allowing a moving body which moves while carrying a user who is executing a work to:
acquire work information in relation to the work to be executed by the user in the moving body; and
adjust a working environment in the moving body by changing at least any one of setting of equipment of the moving body, a traveling condition, and a traveling route on the basis of the work information.

6. A non-transitory storage medium stored with a work support program for allowing a computer of a moving body which moves while carrying a user who is executing a work to execute:
a step of acquiring work information in relation to the work to be executed by the user in the moving body; and
a step of adjusting a working environment in the moving body by changing at least any one of setting of equipment of the moving body, a traveling condition, and a traveling route on the basis of the work information.

7. A work support system comprising:
a moving body which moves while carrying a user who is executing a work; and
a manager configured to manage the moving body, the manager including:
an acquirer configured to acquire work information in relation to the work to be executed by the user in the moving body; and
an instructor configured to transmit, to the moving body, an instruction to change at least any one of setting of equipment of the moving body, a traveling condition, and a traveling route on the basis of the work information, and the moving body including:
an adjuster configured to adjust a working environment in the moving body by changing at least any one of the equipment, the traveling condition, and the traveling route by receiving the instruction from the manager.
